(19) United States
(12) Patent Application Publication
(10) Pub. No.: US 2014/0341263 A1
(43) Pub. Date: Nov. 20, 2014

(54) CALIBRATION METHOD PERFORMING SPECTRUM ANALYSIS UPON TEST SIGNAL AND ASSOCIATED APPARATUS FOR COMMUNICATION SYSTEM

(71) Applicant: Realtek Semiconductor Corp., HsinChu (TW)

(72) Inventors: Chih-Yung Wu, Changhua County (TW); Chung-Yao Chang, Hsinchu County (TW)

(73) Assignee: Realtek Semiconductor Corp., HsinChu (TW)

(21) Appl. No.: 14/277,796

(22) Filed: May 15, 2014

(30) Foreign Application Priority Data
May 15, 2013 (TW) 102117260

(51) Int. Cl. H04B 17/00

(52) U.S. Cl. CPC H04B 17/0015
USPC 375/224

(57) ABSTRACT

A calibration method for calibrating a communication system includes: generating a test signal at a transmitter; configuring at least one calibration coefficient at the transmitter; configuring at least one calibration coefficient at the receiver; transmitting the test signal to a receiver via the calibration coefficient; performing a spectrum analysis upon the test signal received by the receiver to generate a spectrum analysis result; and adjusting the calibration coefficient according to the spectrum analysis result to calibrate the transmitter. In addition, a calibration method is also provided for calibrating a receiver of a communication system, and related calibration apparatuses are further provided.

### BACKGROUND OF THE INVENTION

1. Field of the Invention

The disclosed embodiments of the present invention relate to calibration methods and associated apparatuses for a communication system, and more particularly, to calibration methods and associated apparatuses for a wireless transceiver based on a Quadrature Amplitude Modulation (QAM).

2. Description of the Prior Art

Transmission rates for communication systems have become higher as the communication systems develop. As a signal modulated by a more complicated modulation technique contains more information than a signal modulated by a less complicated modulation technique, designers can raise the transmission rate by adopting high level complicated process, such as 64-Quadrature Amplitude Modulation (64-QAM), or even 256-QAM. In order to optimize transmission of a high level Quadrature Amplitude Modulation, an Error Vector Magnitude (EVM) of a communication system has to be raised. One of the most significant factors that affect the EVM is In-phase Quadrature-phase imbalance (IQ imbalance), whose root cause is IQ mismatch of a Radio Frequency (RF) circuit, where even a slight mismatch can reduce overall performance of the communication system. Specifically, the imperfect Quadrature Amplitude Modulation/Demodulation introduced by mismatches leads to a poor Bit Error Rate (BER). Mismatches can be divided into amplitude mismatch and phase mismatch. Once these mismatches exist, an unwanted image signal will be generated at symmetric frequency.

Please refer to FIG. 1, which is a diagram illustrating a single tone signal received by a receiver and an image signal generated by the received signal. The difference between the amplitude of the received signal and the amplitude of the image signal is called Image Ratio (IMR). A serious IQ imbalance will lead to a small IMR, and vice versa.

In order to improve the above issues, a calibration process is usually performed before formal signal transmission and reception in a real circuit. The calibration process is called IQ calibration. A communication system may be affected in many ways under many different circumstances, such as different temperatures, different channels, a different low-noise amplifier (LNA) and a different power amplifier (PA). Thus, when and how to perform calibration for an IQ mismatch has become an important issue in this field.

### SUMMARY OF THE INVENTION

One of the objectives of the present invention is to provide calibration methods and associated apparatuses for a communication system, and more particularly, to provide calibration methods and associated apparatuses for a wireless transceiver based on a Quadrature Amplitude Modulation (QAM) in order to resolve issues in the prior art.

According to a first embodiment of the present invention, a calibration method for a communication system is disclosed. The calibration method comprises the following steps: generating a test signal at a transmitter; configuring at least one calibration coefficient at the transmitter; transmitting the test signal from the transmitter to a receiver via the calibration coefficient; performing a spectrum analysis upon the test signal received by the receiver to generate a spectrum analysis result; and adjusting the calibration coefficient according to the spectrum analysis result to calibrate the transmitter.

According to a second embodiment of the present invention, a calibration method for a communication system is disclosed. The calibration method comprises the following steps: generating a test signal at a transmitter; configuring at least one calibration coefficient at a receiver; transmitting the test signal from the transmitter to the receiver via the calibration coefficient; performing a spectrum analysis upon the test signal received by the receiver to generate a spectrum analysis result; and adjusting the calibration coefficient according to the spectrum analysis result to calibrate the receiver.

According to a third embodiment of the present invention, a calibration apparatus for a communication system is disclosed. The calibration apparatus includes a transmitter, a test signal generator, a calibration coefficient configuring unit, a receiver and a spectrum analysis unit. The test signal generator is arranged for generating a test signal at the transmitter. The calibration coefficient configuring unit is arranged for configuring at least one calibration coefficient at the transmitter, and adjusting the calibration coefficient according to a spectrum analysis result. The receiver is coupled to the transmitter. The spectrum analysis unit is arranged for performing a spectrum analysis upon the test signal received by the receiver to generate a spectrum analysis result.

According to a fourth embodiment of the present invention, a calibration apparatus for a communication system is disclosed. The calibration apparatus includes a transmitter, a test signal generator, a receiver, a calibration coefficient configuring unit and a spectrum analysis unit. The test signal generator is arranged for generating a test signal at the transmitter. The receiver is coupled to the transmitter. The calibration coefficient configuring unit is arranged for configuring at least one calibration coefficient at the receiver, and adjusting the calibration coefficient according to the spectrum analysis result. The spectrum analysis unit is arranged for performing a spectrum analysis upon the test signal received by the receiver to generate a spectrum analysis result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a single tone signal received by a receiver and an image signal generated by the received signal.

FIG. 2 is a diagram illustrating a communication system which has a calibration apparatus embedded according to a first embodiment of the present invention.

FIG. 3 is a flowchart illustrating a calibration method for a communication system according to an embodiment of the present invention.

FIG. 4 is a flowchart illustrating a test signal power adjustment method according to an embodiment of the present invention.

FIG. 5 is a flowchart illustrating a calibration coefficient adjustment method according to an embodiment of the present invention.

FIG. 6 is a diagram illustrating a communication system which has an embedded calibration apparatus according to a second embodiment of the present invention.

FIG. 7 is a diagram illustrating a communication system which has an embedded calibration apparatus according to a third embodiment of the present invention.

FIG. 8 is a flowchart illustrating a calibration method for a communication system according to an embodiment of the present invention.

FIG. 9 is a diagram illustrating a recalibration method according to an embodiment of the present invention.

FIG. 10 is a diagram illustrating a recalibration method according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

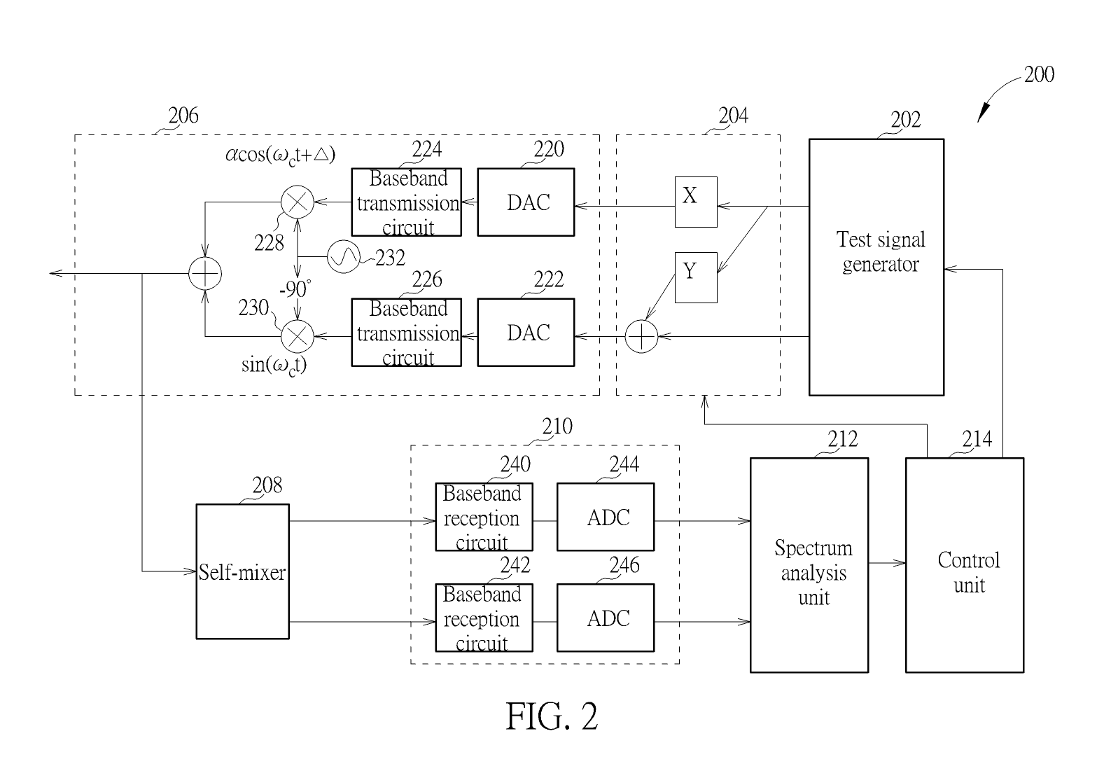

Please refer to FIG. 2, which is a diagram illustrating a communication system having an embedded calibration apparatus according to a first embodiment of the present invention. The communication system 200 includes at least one portion (e.g. a portion or all) of an electronic device. For example, the apparatus 100 may comprise a portion of the electronic device mentioned above, and more particularly, can be a control circuit such as an integrated circuit (IC) within the electronic device. In another example, the apparatus 100 can be the whole of the electronic device mentioned above. Examples of the electronic device may include, but are not limited to, a mobile phone (e.g. a multifunctional mobile phone), a mobile computer (e.g. tablet computer), a personal digital assistant (PDA), and a personal computer such as a laptop computer. For example, the communication system 200 may be a process module of the electronic device, such as a processor. In another example, the communication system 200 may be the entire electronic device; however, this is for illustrative purposes, and not a limitation of the present invention. In practice, any alternative design can achieve the same or similar functions. According to an alternative design of the present invention, the communication system 200 is a system of the electronic device, and the electronic device is a sub-system of the system. More particularly, the electronic device may include a Quadrature Amplitude Modulation (QAM) circuit, wherein the communication system 200 is able to calibrate said QAM circuit, although this is not a limitation of the present invention.

As shown in FIG. 2, the communication system 200 includes: a test signal generator 202, a calibration coefficient unit 204, a transmitter 206, a self-mixer 208, a receiver 210, a spectrum analysis unit 212 and a control unit 214. According to the present invention, every time the communication system 200 is reactivated (e.g. after being powered on or reset) but before the normal data transmission and reception mode starts, the control unit 214 controls the communication system 200 to initially enter a calibration mode for improving mismatches of the circuit characteristic between a transmitter in-phase path (i.e. the path through a digital-to-analog converter 220, a baseband transmission circuit 224 and a mixer 228 of the transmitter 206) and a transmitter quadrature-phase path (i.e. the path through a digital-to-analog converter 222, a baseband transmission circuit 226 and a mixer 230 of the transmitter 206) of the transmitter 206. In other words, the deviation between the in-phase path and the quadrature-phase of the transmitter will be optimally calibrated at the calibration mode, and the receiver 210 will then be calibrated in a similar way. Lastly, the transmitter 206 and the receiver 210 will enter the normal data transmission and reception mode, at which time data transmission and reception will be performed formally. This is for illustrative purposes, and not a limitation of the present invention. In practice, any alternative designs can achieve the same or similar functions.

The mixer 228 at ideal status performs a cos(ω_{c}t) operation upon a signal transmitted from the baseband transmission circuit 224 with a specific frequency of the oscillator 232. After taking errors of the real circuit into consideration, all the errors of the in-phase path can be classified into a joint amplitude error and a joint phase error. Furthermore, after a joint amplitude error coefficient αᵢ and a joint phase error coefficient Δᵢ are added, the equation above may be rewritten as αᵢ cos(ω_{c}t+Δᵢ), wherein the subscript i of the joint amplitude error coefficient αᵢ and the joint phase error coefficient Δᵢ represents the in-phase path. Similarly, the mixer 230 at ideal status performs a sin(ω_{c}t) operation upon a signal transmitted from the baseband transmission circuit 226 with a specific frequency of the oscillator 232. After taking errors of the real circuit into consideration, all the errors of the quadrature-phase path can be classified into a joint amplitude error and a joint phase error. Furthermore, after a joint amplitude error coefficient α_{g} and a joint phase error coefficient Δ_{q} are added, the equation above may be rewritten as α_{q} sin(ω_{c}t+Δ_{q}), wherein the subscript q of the joint amplitude error coefficient α_{g} and the joint phase error coefficient Δ_{q} represents the quadrature-phase path. In order to simplify the complexity and computing time of the calibration process, the error coefficients of the in-phase path and the quadrature-phase path can be further simplified. Since the calibration process of the present invention is dedicated to mismatches or deviations between the in-phase path and the quadrature-phase path, the expression of the mixer 228 can be simplified as α cos(ω_{c}t+Δ), and the expression of the mixer 230 can be simplified as sin(ω_{c}t). Therefore, only the two coefficients are required to be optimized according to the present invention. This is for illustrative purpose, and not a limitation of the present invention. In practice, any alternative designs can achieve the same or similar functions. Details of the calibration mode are given in the following paragraphs.

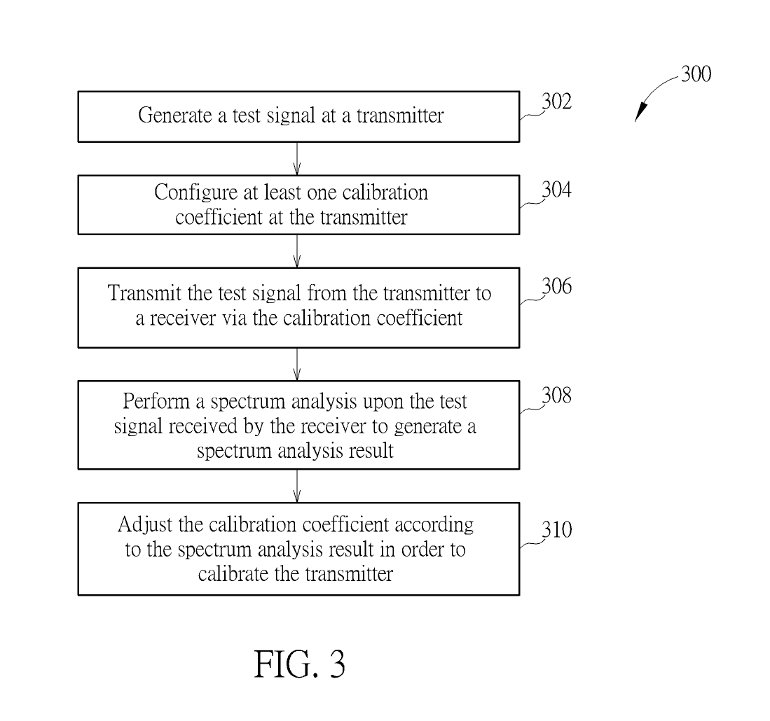

FIG. 3 is a flowchart illustrating the calibration method 300 for a communication system according to an embodiment of the present invention. Provided that substantially the same result is achieved, the steps in FIG. 3 need not be in the exact order shown and need not be contiguous; that is, other steps can be intermediate. Some steps in FIG. 3 may be omitted according to various embodiments or requirements. The calibration method 300 can be applied to the communication system 200 shown in FIG. 2, wherein the test signal generator 202, the calibration coefficient unit 204, the spectrum analysis unit 212 and the control unit 214 are utilized to perform the calibration method 300 upon the transmitter 206. The calibration method 300 comprises the following steps.

In Step 302, the control unit 214 of the communication system 200 controls the test signal generator 202 to produce a test signal, and the test signal is sent to the calibration coefficient unit 204. For example, the test signal may be continuous and stick to a specific value, and may be further encoded by a specific coding rule. In addition, the test signal generator 202 may be implemented by a hardware circuit or a program code executed by a processor.

In Step 304, another built-in calibration coefficient unit 204 of the communication system 200 includes at least a calibration coefficient. For instance, in the present invention, the calibration coefficient unit 204 possesses two calibration coefficients, which are a first coefficient X and a second coefficient Y. As shown in FIG. 2, the first coefficient X is for calibrating the in-phase path, and the second coefficient Y is for calibrating the quadrature-phase path. This is for illustrative purposes only, and not a limitation of the present invention. Adopting more calibration coefficients may happen in practice, accompanied by more complicated mathematics. It should be noted that the initial value of the first coefficient X can be set to 1, and the initial value of the second coefficient Y can be set to 0. Ideally (i.e. mismatches are precluded), the first coefficient X is 1 and the second coefficient Y is 0. Details regarding determining the optimal value are provided in the following paragraphs.

In Step 306, the test signal of Step 302 is transmitted from the test signal generator unit 202. The test signal passes through the calibration coefficient of the calibration coefficient unit 204, the transmitter 206 of the communication system 200, the self-mixer 208 of the communication system 200, and is then fed back to the receiver 210 of the communication system 200. Therefore, a received test signal at the receiver 210 can be used to calibrate the communication system 200. Details regarding the feedback are provided in the following paragraphs.

In Step 308, the spectrum analysis unit 212 is utilized to perform a spectrum analysis upon the received test signal outputted by the receiver 210, to generate a spectrum analysis result. In this embodiment, the spectrum analysis result is a power spectrum density (PSD).

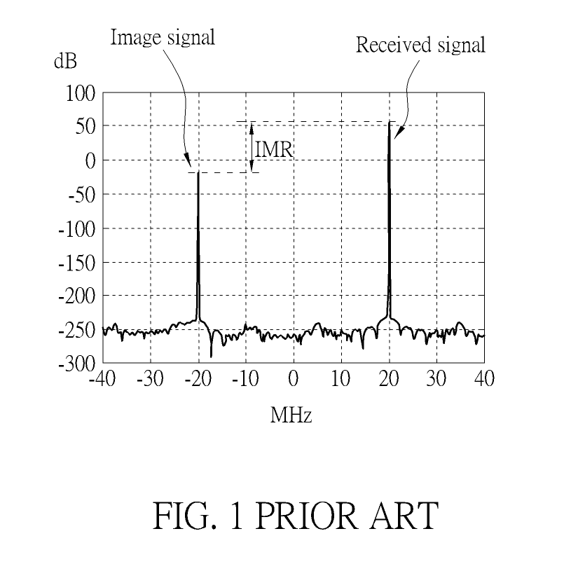

In Step 310, the spectrum analysis result generated by the spectrum analysis unit 212 is utilized to adjust the calibration analysis of the transmitter 206 to calibrate the transmitter 206. For example, in this embodiment, the PSD produced by the spectrum analysis unit 212 can be referenced to compute the image ratio (IMR) shown in FIG. 1. Accordingly, a corresponding adjustment for the first coefficient X and the second coefficient Y of the calibration coefficient adjustment unit 204 can be made. Meanwhile, the IMR is followed as an indicator for the next move of the adjustment. In this way, a recursive adjusting loop is formed, and adjustment of the first coefficient X and/or the second coefficient Y are kept going until the control unit 214 declares the calibration process is over, at which point the calibration mode will formally halt and the communication system 200 will enter the normal data transmission and reception mode.

According to the present invention, the test signal generated by the test signal generator 202 passes the in-phase path and the quadrature-phase path respectively, and is then processed by downstream components such as the digital-to-analog converter 220 and the corresponding digital-to-analog converter 222, the baseband circuit 224 and the corresponding baseband circuit 226, and the mixer 228 and the corresponding mixer 230. The mixer 228 and the mixer 230 perform up-conversion which allows the up-converted signal to be carried on a high frequency carrier. The two paths are then merged and transmitted by the transmitter 206. Since the embodiment is dedicated to the calibration process of the transmitter 206, when feeding back the test signal to the spectrum analysis unit 212, the modulation circuits of the receiver 210 (not shown in FIG. 2) are deliberately bypassed. The main purpose is to bypass the modulation circuits of the receiver 210, which are the main sources of mismatch errors of the receiver 210. In this way, the transmitter 206 can be calibrated alone without affecting the receiver 206. In order to feed the RF signal generated by the transmitter 206 into the baseband circuit 240 and the baseband circuit 242 of the transmitter 206, the RF signal has to be converted to the baseband signal by the self-mixer 208, and the modulation circuit of the receiver 210 has to be bypassed as mentioned above.

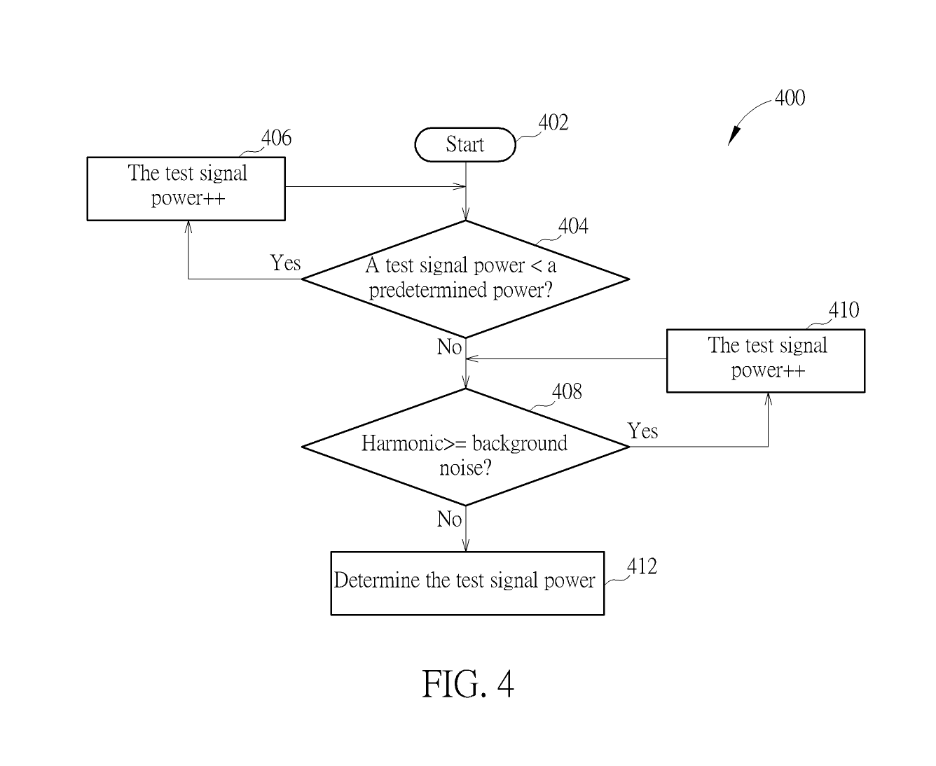

As demonstrated by the above description, each time the communication system 200 is reactivated (e.g. after being powered on or reset) but before the normal data transmission and reception mode starts, the control unit 214 controls the communication system 200 to initially enter a calibration mode for improving mismatches of the circuit characteristic between a transmitter in-phase path and a transmitter quadrature-phase path of the transmitter 206. In practice, the calibration mode can be further divided into two stages. At the first stage, the control unit 214 controls the test signal generator 202 to generate a test signal, and determines whether to strengthen or weaken the test signal according to the signal power received by the spectrum analysis unit 212. The purpose is to tune the test signal gain to an appropriate rage so the second stage can be proceeded to smoothly. Please refer to FIG. 4, which is a flowchart illustrating the test signal power adjustment method 400 according to an embodiment of the present invention. Provided that substantially the same result is achieved, the steps in FIG. 4 need not be in the exact order shown and need not be contiguous; that is, other steps can be intermediate. Some steps in FIG. 4 may be omitted according to various types of embodiments or requirements. The test signal power adjustment method 400 can be applied to the communication system 200 shown in FIG. 2, especially the control unit 214 thereof. The calibration method 300 comprises the following steps.

In Step 402, when the communication system 200 starts to enter the calibration mode, or in other words, before adjusting the calibration coefficient of the transmitter 206 (e.g. the first coefficient X and the second coefficient Y) according to the spectrum analysis result, the control unit 214 resets the calibration coefficient unit 204 to the predetermined initial configuration, in order to set the first coefficient X and the second coefficient Y to 1 and 0 respectively. The test signal generator 202 of the transmitter 206 transmits the test signal pursuant to a notification indicated by the control unit 214. In Step 404, the spectrum analysis result is referred to, wherein if the spectrum analysis result indicates the power of the test signal is lower than a predetermined power, the test signal generator 202 of the transmitter 206 will be notified to increase the power of the test signal. If the spectrum analysis result indicates the power of the test signal is not lower than a predetermined power, the power scale requirement of the test signal will be regarded as substantially fulfilled. In Step 408, the spectrum analysis result is further taken into consideration to decide whether the test signal induces excessive harmonic. If the test signal has any harmonic which is greater or equal to the background noise in respect of power, the control unit 214 will notify the test signal generator 202 of the transmitter to reduce the power of the test signal on basis of a specific step, so as to suppress the induced harmonic thereby increasing accuracy of the following calibration process; on the other hand, if the test signal does not have any harmonic which is greater or equal to the background noise in respect of power, the control unit 214 will notify the test signal generator 202 of the transmitter to fix the power of the test signal under current condition.

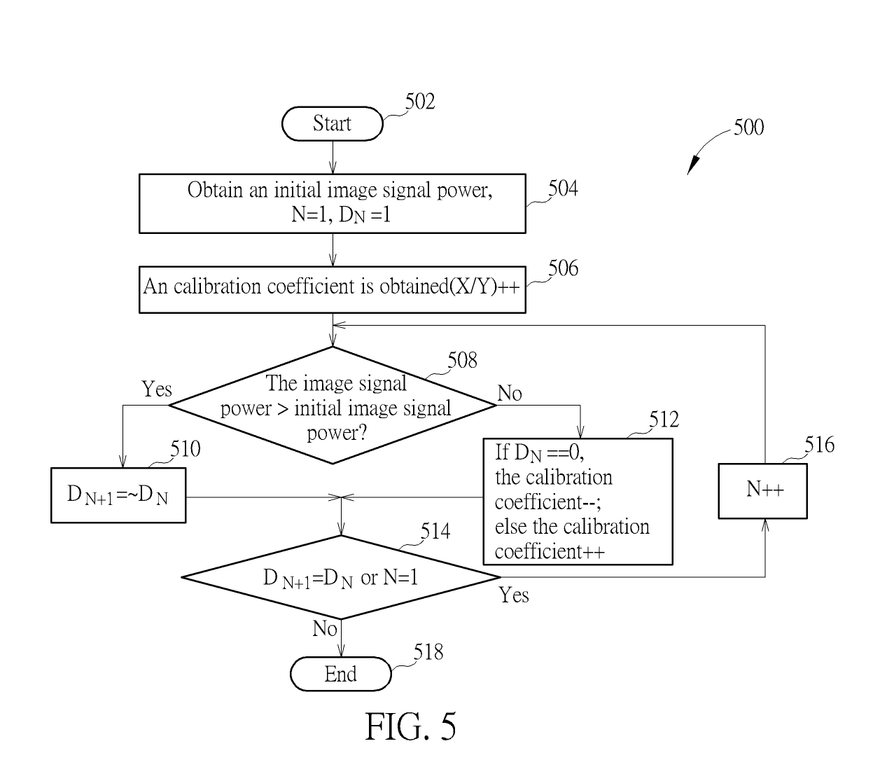

As mentioned above, the calibration mode has two stages. After the first stage ends, the second stage will be entered. At the second stage, the control unit 210 controls the test signal generator 202 to produce the test signal in accordance with the power magnitude of the test signal derived at the first stage, and determines whether to adjust the first coefficient X and the second coefficient Y included in the calibration coefficient unit 204 in accordance with the scale of the signal power received by the spectrum analysis unit 212. In this embodiment, the first coefficient X and the second coefficient Y are adjusted separately. Specifically, at the second stage, the first coefficient X is tuned alone while keeping the second coefficient Y unchanged. Once the first coefficient X is determined, the second coefficient Y is tuned alone while keeping the first coefficient X unchanged. Please refer to FIG. 5, which is a flowchart illustrating the calibration coefficient adjustment method 500 according to an embodiment of the present invention. Provided that substantially the same result is achieved, the steps in FIG. 5 need not be in the exact order shown and need not be contiguous; that is, other steps can be intermediate. Some steps in FIG. 5 may be omitted according to various types of embodiments or requirements. The calibration coefficient adjustment method 500 can be applied to the communication system 200 shown in FIG. 2, and in particular to the control unit 214. The calibration coefficient adjustment method 500 comprises the following steps.

In Step 502, when the communication system 200 starts to enter the second stage of the calibration mode, the control unit 214 resets the calibration coefficient unit 204 to the predetermined initial configuration, i.e. to set the first coefficient X and the second coefficient Y to 1 and 0 respectively. The control unit 214 instructs the test signal generator 202 of the transmitter 206 to produce the test signal pursuant to the magnitude of the test signal power determined at the first stage. In Step 504, an initial image signal power is obtained and recoded according to the spectrum analysis result, and a loop number N is set to 1, and an adjustment direction D_{N} is also set to 1. In Step 506, the first coefficient is increased on the basis of a specific step. Please note that, in Step 502 and Step 504, arbitrarily selecting a direction to adjust the first coefficient X is acceptable in practice, since it is at an initial state. For instance, the adjustment direction D_{N} can also be set to 0, and the first coefficient X is decreased on the basis of the specific step.

In Step 508, the spectrum analysis unit 212 obtains the image signal power corresponding to the adjustment made for the first coefficient X at the previous step. If the image signal power is higher than the initial image signal power of Step 504, it will be regarded as an indication that the adjustment direction D_{N} (which was determined arbitrarily) was made in the wrong direction. To continue in the same direction would only increase the initial image signal power; hence, Step 510 is entered. This gives the control unit 214 a chance to turn around the calibration coefficient adjustment direction, i.e. D_{N+1}=˜D_{N}, in order to derive the calibration coefficient correctly. If the image signal power is not higher than the initial image signal power of Step 504, it will be regarded as an indication that the adjustment direction D_{N} was determined in the correct direction. To continue in the same direction would decrease the initial image signal power; hence, Step 512 is entered. The adjustment direction is therefore maintained, i.e. D_{N+1}=D_{N}, so as to derive the calibration coefficient correctly. In addition, the initial image signal power has to be updated to the currently estimated image signal power for comparison in the next loop.

Step 510 and Step 512 are both followed by Step 514. In Step 514, the next adjustment direction D_{N+1} decided in the previous step is compared with the current adjustment direction D_{N}. If the two adjustment directions are the same, Step 516 will be entered, where the loop number N is set to N+1, and then Step 508 will be entered again for adjusting the next loop; if the two adjustment directions are not the same, there will be two conclusions to be made. The first conclusion is that the adjustment direction arbitrarily determined at the initial state is wrong, and the control unit 214 will accordingly enter Step 516 and set the loop number N to N+1, then return to Step 508 for adjusting the next loop. The other conclusion is that the adjustment of the first coefficient at the second stage has been completed, which means the minima of the image signal power falls between the current loop and the previous loop. In other words, the optimized first coefficient X falls between the values corresponding to the current loop and the previous loop. In this way, calibration of the second stage can be halted by entering Step 518. After adjusting the first coefficient X at the second stage, the first coefficient X can be fixed. A similar method is used for adjusting the second coefficient Y (i.e. by replacing the first coefficient of Steps 506 and 512 shown in FIG. 5 with the second coefficient, and going through the same process mentioned above to obtain the optimized second coefficient Y). Details therein are omitted here for brevity.

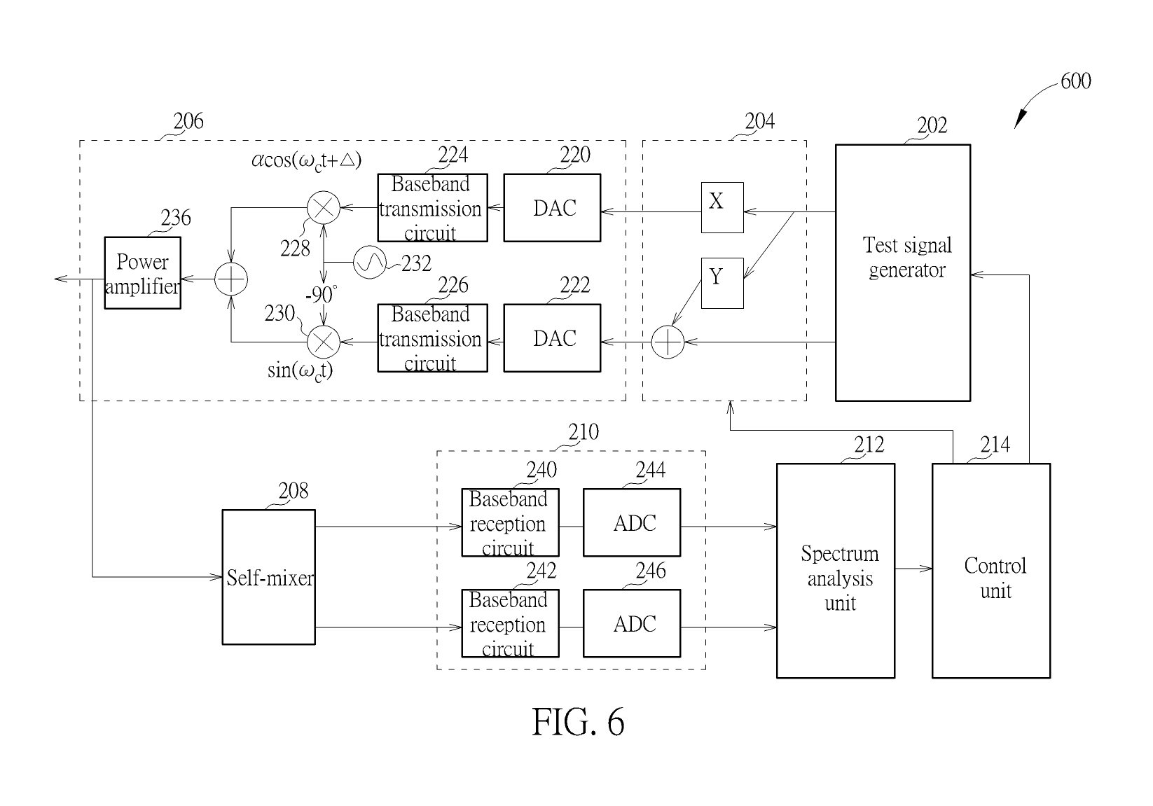

Depending on the electrical characteristic inside an integrated circuit and the scale of a power amplifier, the design methodologies may alter, hence the electrical characteristic between the in-phase path and the quadrature-phase path may be affected, or even introduce mismatches. In a general case, multiple power amplifiers are employed in a transmitter of a communication system for selection or arbitrary combination, as detailed in another embodiment of the present invention. In this embodiment, multiple power amplifiers can be calibrated together, so that a more accurate calibration coefficient of the overall transmitter can be obtained. Please refer to FIG. 6, which is a diagram illustrating a communication system having an embedded calibration apparatus. The communication system 600 is similar to the communication system 200. The main difference is that the communication system 600 comprises a power amplifier 236. In the calibration mode, the test signal generated by the test signal generator 202 passes the in-phase path and the quadrature-phase path, and is then processed by downstream components such as the digital-to-analog converter 220 and the corresponding digital-to-analog converter 222, the baseband circuit 224 and the corresponding baseband circuit 226, and the mixer 228 and the corresponding mixer 230. The mixer 228 and the mixer 230 perform up-conversion which allows the up-converted signal to be carried on a high frequency carrier. The two paths are then merged and transmitted by the transmitter 206. Furthermore, the power amplifier 236 is passed before the end of the transmitter 206, which is different from the aforementioned embodiment. The following signal process is substantially the same as the abovementioned embodiment, i.e. passing through the self-mixer 208, the receiver 210, the spectrum analysis unit 212 and the control unit 214. In this embodiment, the communication system 600 is allowed to be calibrated with different power amplifiers and consequently a plurality of corresponding calibration coefficients can be derived. Once the communication system 600 enters the normal data transmission mode, the corresponding calibration coefficient will be selected according to the power amplifier, which corresponds to the power of the signal to be transmitted. No matter whether a single specific power amplifier or a power amplifier combination including more than one power amplifier is adopted, the calibration coefficients derived at the calibration mode can be utilized to directly produce or compose the corresponding best calibration coefficient. Further details of this embodiment which are similar to the aforementioned embodiment/alternative designs are omitted here for brevity.

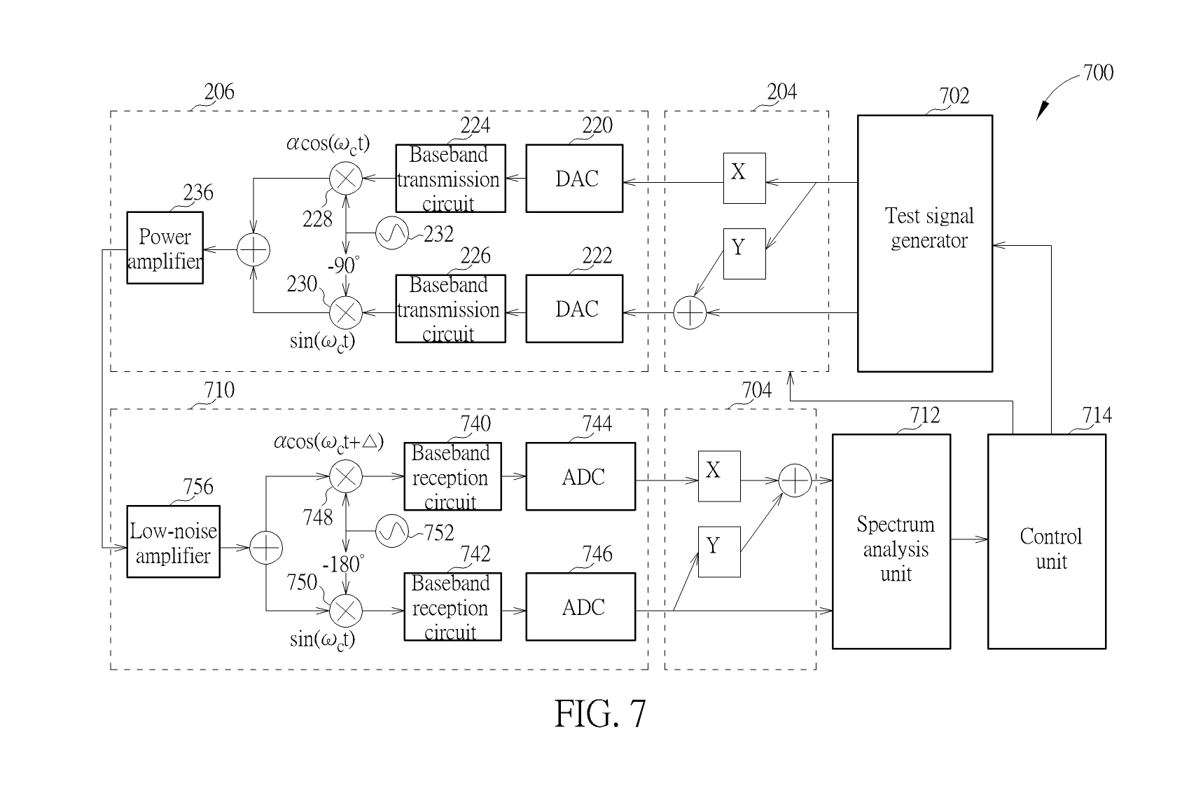

Please refer to FIG. 7, which is a diagram illustrating a communication system having an embedded calibration apparatus according to a third embodiment of the present invention. As shown in FIG. 7, the communication system 700 includes a test signal generator 702, the calibration coefficient unit 204 and the transmitter 206 of the aforementioned embodiment, a receiver 710, a spectrum analysis unit 712 and a control unit 714. According to this embodiment, each time the communication system 700 is reactivated (e.g. after being powered on or reset) but before the normal data transmission and reception mode starts, the abovementioned transmitter calibration process are performed on the receiver 206, wherein a low-noise amplifier 756, a mixer 742 and a mixer 750 of the receiver 710 are skipped/omitted. After the calibration coefficients (e.g. the first coefficient X and the second coefficient Y) of the transmitter 206 are confirmed, the calibration process continues to improve mismatches of the circuit characteristic between a receiver in-phase path (i.e. the path through a low-noise amplifier 756, a mixer 748, a baseband reception circuit 740 and an analog-to-digital converter 744 of the receiver 710) and a receiver quadrature-phase path (i.e. the path through a low-noise amplifier 756, a mixer 750, a baseband reception circuit 742 and an analog-to-digital converter 746 of the receiver 710) of the receiver 710. Hence, the control unit 714 controls the communication system 700 to remain in the calibration mode. After the calibration of the transmitter 206 has been completed, the deviation between the in-phase path and the quadrature-phase of the receiver will be optimally calibrated at the calibration mode. Lastly, the transmitter 206 and the receiver 710 will enter the normal data transmission and reception mode, at which point data transmission and reception will be performed formally. Yet this is for illustrative purpose, and not a limitation of the present invention. Actually, any alternative designs can achieve the same or similar functions and comply with the spirit of the present invention all fall into the scope of the present invention.

Similarly, the mismatches between the in-phase path and the quadrature-phase path of the receiver are mainly contributed by the mixer 748 and the mixer 750. After taking errors of the real circuit into consideration, all of the errors of the in-phase path can be classified into a joint amplitude error and a joint phase error. Furthermore, the error coefficient of the in-phase path and the error coefficient of the quadrature-phase path may be rewritten as α cos(θ_{c}t+Δ) and sin(ω_{c}t). As a result, the calibration can be made by simply adjusting the two coefficients (i.e. the first coefficient X′ and the second coefficient Y′). Details regarding the operations of the calibration mode are provided in the following paragraphs.

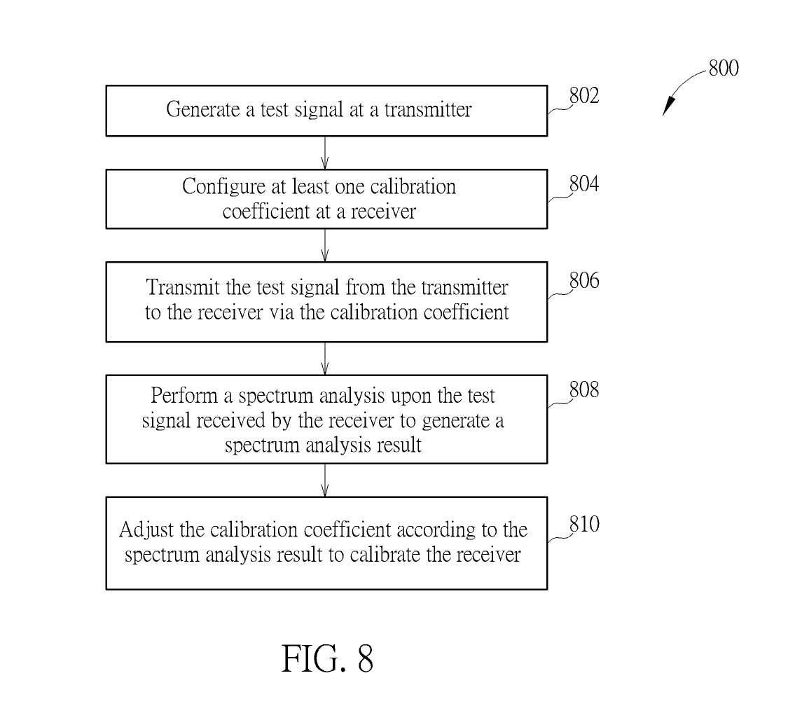

FIG. 8 is a flowchart illustrating the calibration method 800 for a communication system according to an embodiment of the present invention. Provided that substantially the same result is achieved, the steps in FIG. 8 need not be in the exact order shown and need not be contiguous; that is, other steps can be intermediate. Some steps in FIG. 8 may be omitted according to various types of embodiments or requirements. The calibration method 800 can be applied to the communication system 700 shown in FIG. 7, wherein the test signal generator 702, the calibration coefficient configuring unit 704, the spectrum analysis unit 712 and the control unit 714 are utilized to perform the calibration method 800 upon the receiver 710. The calibration method 800 comprises the following steps.

In Step 802, the control unit 714 of the communication system 700 controls the test signal generator 702 to produce a test signal, and the test signal is sent to the calibration coefficient configuring unit 704. For example, the test signal may be continuous and stick to a specific value, and may be further encoded by a specific coding rule. Please note this is for illustrative purposes, and not a limitation of the present invention. In addition, the test signal generator 702 may be implemented by hardware circuits or program code executed by a processor.

In Step 804, another built-in calibration coefficient configuring unit 712 of the communication system 700 includes at least a calibration coefficient. For instance, in the present invention, the calibration coefficient configuring unit 704 possesses two calibration coefficients, which are a first coefficient X′ and a second coefficient Y′. As shown in FIG. 7, the first coefficient X′ is for calibrating the in-phase path and the second coefficient Y′ is for calibrating the quadrature-phase path. This is for illustrative purposes only, and not a limitation of the present invention. Adopting more calibration coefficients may occur in practice, accompanied by more complicated mathematics. It should be noted that the initial value of the first coefficient X′ can be set to 1, and the initial value of the second coefficient Y′ can be set to 0. In other words, ideally (i.e. mismatches are precluded) the first coefficient X′ is 1 and the second coefficient Y′ is 0. Details regarding determining the optimal value are given in the following paragraphs.

In Step 806, the test signal of Step 802 is transmitted from the test signal generator unit 702. The test signal passes through the transmitter 206 of the communication system 700 and is fed back to the receiver 710 of the communication system 700. The test signal passes the calibration coefficient of the calibration coefficient configuring unit 704, and a received test signal is obtained. Therefore, the received test signal can be used to calibrate the communication system 700. Details regarding the feedback are given in the following paragraphs.

In Step 808, the spectrum analysis unit 712 is utilized to perform a spectrum analysis upon the received test signal outputted by the receiver 710, to generate a spectrum analysis result. In this embodiment, the spectrum analysis result is a power spectrum density (PSD).

In Step 810, the spectrum analysis result generated by the spectrum analysis unit 712 is utilized to adjust the calibration analysis of the receiver 710 to calibrate the receiver 710. For example, in this embodiment, the PSD produced by the spectrum analysis unit 712 can be referenced to compute the image ratio (IMR) shown in FIG. 1. Accordingly, a corresponding adjustment for the first coefficient X′ and the second coefficient Y′ of the calibration coefficient adjustment unit 704 can be made. At the same time, the IMR is followed as an indicator for the next move of the adjustment. In this way, a recursive adjusting loop is formed, and adjustment of the first coefficient X′ and the second coefficient Y′ are continued until the control unit 714 declares the calibration process is over, at which point the calibration mode will formally halt and the communication system 700 will enter the normal data transmission and reception mode.

According to the present invention, the test signal generated by the test signal generator 702 passes the calibration coefficient unit 204 and the transmitter 206, and enters the receiver 710 by way of coupling. Please note this is for illustrative purposes, rather than a limitation of the present invention. In practice, the input terminal of the power amplifier 236 may be coupled to the output terminal of the low-noise amplifier 756, or the output terminal of the power amplifier 236 may be coupled to the input terminal of the low-noise amplifier 756. The output power of the power amplifier 236 is higher than all other signals of the transmitter 206. Consequently, the coupling signal seen by the receiver 710 is mostly contributed by the test signal outputted by the power amplifier 236. The outputted test signal is then extracted from the carrier as a result of down conversion performed by the mixer 748 and the mixer 750 of the receiver 710, and then processed by downstream components such as the baseband circuit 740 and the corresponding baseband circuit 742, the analog-to-digital converter 744 and the corresponding analog-to-digital converter 746, the calibration coefficient configuring unit 704 and the spectrum analysis unit 712. In addition, any further details regarding the adjustment method for the first coefficient X′ and the second coefficient Y′, or the calibration method for the multiple low-noise amplifier of the low-noise amplifier 756 of this embodiment which are similar to the aforementioned embodiments/alternative designs are omitted here for brevity.

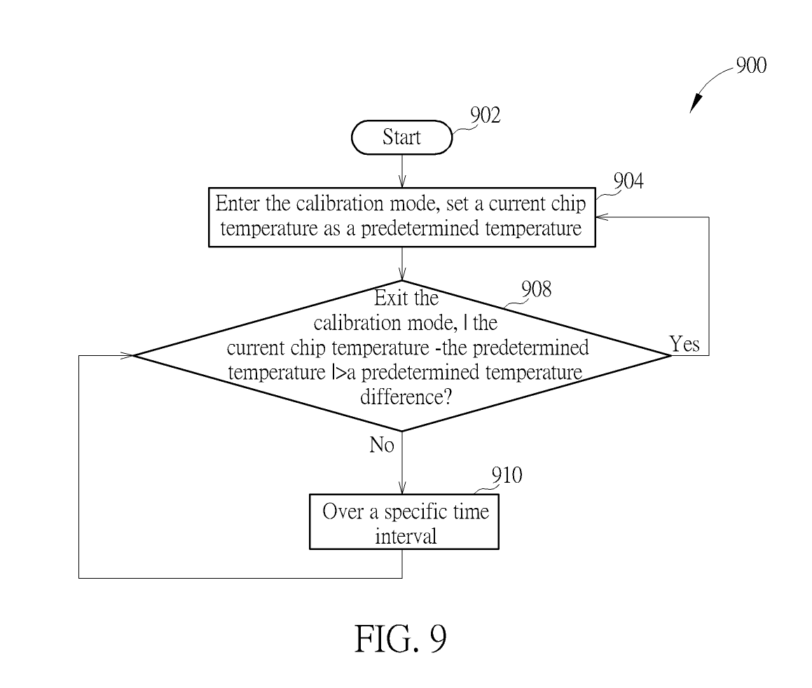

According to the embodiment above, each time a communication system is reactivated (e.g. after being powered on or reset), the communication will be calibrated and then enter the normal data transmission and reception mode. The electrical characteristic of the integrated circuit may change with temperature. The bit error rate (BER) may go high as a result of circuit mismatches induced by temperature variation. According to another embodiment of the present invention, a real time recalibration mechanism is disclosed. Please refer to FIG. 9, which is a diagram illustrating a recalibration method 900 according to an embodiment of the present invention. Provided that substantially the same result is achieved, the steps in FIG. 9 need not be in the exact order shown and need not be contiguous; that is, other steps can be intermediate. Some steps in FIG. 9 may be omitted according to various types of embodiments or requirements. The recalibration method 900 can be applied to the communication systems 200,600, 700 shown in FIG. 2, FIG. 6 or FIG. 7. The calibration method 900 comprises the following steps.

In Step 902, the communication system is reactivated, and the calibration mode in Step 904 is entered to perform the calibration flow mentioned in the above embodiments. At the same time, a specific unit of the communication system records the current chip temperature as a predetermined temperature. For instance, a control unit of the communication system records the current chip temperature as the predetermined temperature. After the calibration of the communication system is done, Step 906 is entered, such that the communication system starts to formally transmit and receive data. One of the operations of the control unit of the communication is to check whether the difference between the current temperate and the predetermined temperature is greater than a predetermined temperature difference. If the difference between the current temperature and the predetermined temperature is not greater than the predetermined temperature difference, Step 908 will be entered and then Step 906 will be entered again after a specific time interval. For example, the specific time interval may be 5 minutes, and the predetermined temperature difference may be 5° C. In this case, the control unit of the communication system checks the current chip temperature for every 5 minutes. If the difference between the current temperature and the predetermined temperature is greater than 5° C., Step 904 will be entered for communication recalibration.

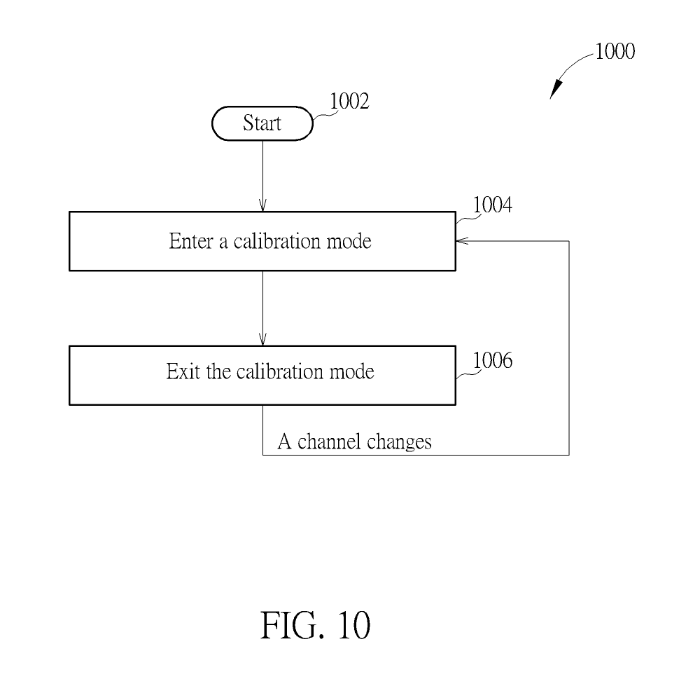

According to the embodiment above, each time a communication system is reactivated (e.g. after being powered on or reset), the communication will be calibrated and then enter the normal data transmission and reception mode. The channel of the communication system may change with environmental variation, which triggers gain switching of the power amplifier or the low-noise amplifier of the communication system. The bit error rate (BER) may go high as a result of circuit mismatches induced by temperature variation. According to another embodiment of the present invention, another real time recalibration mechanism is disclosed. Please refer to FIG. 10, which is a diagram illustrating a recalibration method 1000 according to an embodiment of the present invention. Provided that substantially the same result is achieved, the steps in FIG. 10 need not be in the exact order shown and need not be contiguous; that is, other steps can be intermediate. Some steps in FIG. 10 may be omitted according to various embodiments or requirements. The recalibration method 1000 can be applied to the communication systems 200,600, 700 shown in FIG. 2, FIG. 6 or FIG. 7. The calibration method 1000 comprises the following steps.

In Step 1002, the communication system is reactivated, and the calibration mode in Step 1004 is entered to perform the calibration flow detailed in the above embodiments. After the calibration of the communication system is completed, Step 1006 is entered, such that the communication system starts to formally transmit and receive data. One of the operations of the control unit is to check whether the channel changes. For example, the channel may be changed due to a user manually adjusting the communication system. When the control unit of the communication system receives a notification of the channel variation, Step 1004 will be entered for recalibrating the communication system; otherwise, the flow will remain in Step 1006. The communication system may also change the channel by itself through an automatic adjustment methodology. When the control unit of the communication system receives a notification of the channel variation, Step 1004 will be entered for recalibrating the communication system; otherwise, the flow will remain in Step 1006.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A calibration method for a communication system, comprising:
generating a test signal at a transmitter;
configuring at least one calibration coefficient at the transmitter;
transmitting the test signal from the transmitter to a receiver via the calibration coefficient;
performing a spectrum analysis upon the test signal received by the receiver to generate a spectrum analysis result; and
adjusting the calibration coefficient according to the spectrum analysis result in order to calibrate the transmitter.

2. The calibration method of claim 1, wherein the transmitter and the receiver perform a Quadrature Amplitude Modulation (QAM).

3. The calibration method of claim 2, wherein the calibration coefficient includes at least a first coefficient and a second coefficient, the first coefficient being used for calibrating an in-phase signal path, and the second coefficient being used for calibrating a quadrature-phase signal path.

4. The calibration method of claim 3, wherein the step of transmitting the test signal from the transmitter to the receiver via the calibration coefficient comprises:
performing self-mixing upon the test signal which is transmitted by the transmitter and passes through the calibration coefficient but does not pass through a power amplifier, to generate a self-mixing output; and
feeding the self-mixing output to the receiver without passing through a low-noise amplifier and a down-converter of the receiver.

5. The calibration method of claim 3, wherein the step of transmitting the test signal to the receiver via the calibration coefficient comprises:
performing self-mixing upon the test signal which is transmitted by the transmitter and passes through the calibration coefficient and a power amplifier, to generate a self-mixing output; and
feeding the self-mixing output to the receiver without passing through a low-noise amplifier and a down-converter of the receiver.

6. The calibration method of claim 5, wherein a low-noise amplifier of the transmitter switches between different gains for respectively calibrating corresponding paths.

7. The calibration method of claim 3, further comprising:
before adjusting the calibration coefficient of the transmitter according to the spectrum analysis result, adjusting the test signal according to the spectrum analysis result, wherein the calibration coefficient has a predetermined initial setting;
wherein when the spectrum analysis result indicates a power of the received test signal is less than a predetermined power, the transmitter is notified to increase the power of the test signal;
and when the spectrum analysis result indicates a plurality of harmonic powers of the test signal are higher than the background noise, the transmitter is notified to decrease the power of the test signal.

8. The calibration method of claim 3, wherein the step of adjusting the calibration coefficient of the transmitter according to the spectrum analysis result comprises:
changing the first coefficient on basis of a specific step, to derive a relative minima of an image signal of the test signal.

9. The calibration method of claim 3, wherein the step of adjusting the calibration coefficient of the transmitter according to the spectrum analysis result comprises:
changing the second coefficient on basis of a specific step, to derive a relative minima of an image signal of the test signal.

10. The calibration method of claim 1, which is performed when the transmitter is activated.

11. The calibration method of claim 1, which is performed when the difference between a current temperature measured at the transmitter and a predetermined temperature exceeds a predetermined temperature difference.

12. The calibration method of claim 1, which is performed when the channel currently used by the transmitter alters.

13. The calibration method of claim 1, wherein the spectrum analysis is estimation of the power spectrum density.

14. A calibration method for a communication system, comprising:
generating a test signal at a transmitter;
configuring at least one calibration coefficient at a receiver;
transmitting the test signal from the transmitter to the receiver via the calibration coefficient;
performing a spectrum analysis upon the test signal received by the receiver to generate a spectrum analysis result; and
adjusting the calibration coefficient according to the spectrum analysis result to calibrate the receiver.

15. The calibration method of claim 14, wherein the transmitter and the receiver perform a Quadrature Amplitude Modulation (QAM).

16. The calibration method of claim 15, wherein the calibration coefficient includes at least a first coefficient and a second coefficient, the first coefficient is used to calibrate an in-phase signal path, and the second coefficient is used to calibrate a quadrature-phase signal path.

17. The calibration method of claim 16, wherein the step of transmitting the test signal from the transmitter to the receiver via the calibration coefficient comprises:
coupling the test signal transmitted from the transmitter to the receiver, wherein the test signal passes through the calibration coefficient.

18. The calibration method of claim 17, wherein a calibration coefficient of the transmitter has been calibrated.

19. The calibration method of claim 17, wherein a low-noise amplifier of the transmitter switches between different gains for respectively calibrating corresponding paths.

20. The calibration method of claim 16, further comprising:
before adjusting the calibration coefficient of the transmitter according to the spectrum analysis result, adjusting the test signal according to the spectrum analysis result, wherein the calibration coefficient has a predetermined initial setting;
wherein when the spectrum analysis result indicates a power of the received test signal is less than a predetermined power, the transmitter is notified to increase the power of the test signal;
and when the spectrum analysis result indicates a plurality of harmonic powers of the test signal are higher than the background noise, the transmitter is notified to decrease the power of the test signal.

21. The calibration method of claim 16, wherein the step of adjusting the calibration coefficient of the transmitter according to the spectrum analysis result comprises:
changing the first coefficient on basis of a specific step, so as to derive a relative minima of an image signal of the test signal.

22. The calibration method of claim 16, wherein the step of adjusting the calibration coefficient of the transmitter according to the spectrum analysis result comprises:
changing the second coefficient on basis of a specific step, so as to derive a relative minima of an image signal of the test signal.

23. The calibration method of claim 14, which is performed when the transmitter is activated.

24. The calibration method of claim 14, which is performed when the difference between a current temperature measured at the transmitter and a predetermined temperature exceeds a predetermined temperature difference.

25. The calibration method of claim 14, which is performed when the channel currently used by the transmitter alters.

26. The calibration method of claim 14, wherein the spectrum analysis is estimation of the power spectrum density.

27. A calibration apparatus for a communication system, comprising:
a transmitter;
a test signal generator, arranged for generating a test signal at the transmitter;
a calibration coefficient configuring unit, arranged for configuring at least one calibration coefficient at the transmitter, and adjusting the calibration coefficient according to a spectrum analysis result;
a receiver, coupled to the transmitter; and
a spectrum analysis unit, arranged for performing a spectrum analysis upon the test signal received by the receiver to generate a spectrum analysis result.

28. A calibration apparatus for a communication system, comprising:
a transmitter;
a test signal generator, arranged for generating a test signal at the transmitter;
a receiver, coupled to the transmitter;
a calibration coefficient configuring unit, arranged for configuring at least one calibration coefficient at the receiver, and adjusting the calibration coefficient according to the spectrum analysis result; and
a spectrum analysis unit, arranged for performing a spectrum analysis upon the test signal received by the receiver to generate a spectrum analysis result.
